(19) United States
(12) Patent Application Publication
(10) Pub. No.: US 2015/0248540 A1
(43) Pub. Date: Sep. 3, 2015

(54) METHOD AND SYSTEM FOR MONITORING MEDICATION ADHERENCE

(71) Applicant: Agadia Systems Inc., Parsippany, NJ (US)

(72) Inventors: Scot Alan Lovejoy, Nutley, NJ (US); Srikanth V. Swarna, Randolph, NJ (US)

(21) Appl. No.: 14/633,911

(22) Filed: Feb. 27, 2015

Related U.S. Application Data
(60) Provisional application No. 61/946,129, filed on Feb. 28, 2014.

(51) Int. Cl. G06F 19/00; G06N 5/02

(52) U.S. Cl. CPC G06F 19/3456; G06N 5/027

(57) ABSTRACT

A system and method for monitoring patient adherence to prescribed medications include a processor that analyzes prior authorization data and insurance claims data based on adherence rules, which are user configurable. The system assigns non-adherence cases for user review by creating work queues. Queues may be associated with respective user roles. In response to a non-adherence case, the system generates automated notifications using a notification template. Placeholder variables are insertable into the templates to describe a parameter applicable to a specific instance of non-adherence. The placeholder is replaced by an actual value of the parameter when a notification document is subsequently generated.

### FIELD OF THE INVENTION

The present invention relates to a method and a system for monitoring medication adherence. The method and system may be implemented by, for example, a health plan provider as part of a monitoring process required by a government agency or on a voluntary basis to better service its patients and/or to reduce the financial costs of non-adherence.

### BACKGROUND INFORMATION

Patients sometimes fail to adhere to a prescribed medical regimen, including the taking of one or more prescribed medications. In some instances, they may decide not to fill a prescription or forget to obtain a refill in a timely manner. Other times, patients may be denied coverage for a prescribed medication by their health plan provider (e.g., a private insurance company or a participant in a public health insurance program such as Medicare). When patients are denied coverage, they may seek alternative treatment such as an alternative medication that performs a similar function as the medication for which they were denied. However, some patients may forgo any treatment after being denied. Patients may even forgo treatment when coverage is approved, e.g., because a copayment amount is deemed too high. Depending on the patient's medical condition, the decision to forgo treatment—even a missed refill—may have serious adverse effects on the patient's health, which in turn may result in higher financial costs to the patient's health plan provider in the long term.

Medication adherence is a serious problem in the health care industry—so much so that the Centers for Medicare and Medicaid Services (CMS) has created a five-star quality rating system for evaluating health and prescription drug plans. Under the CMS rating system, adherence to, for example, oral diabetes medications is monitored as part of the evaluation. Plan providers are encouraged to maintain high ratings through financial incentives. For example, plans with a higher star rating are given preference when assigning patients from other health plans that are on probation or were disqualified from participation in Medicare because of non-compliance with Medicare program requirements.

### BRIEF DESCRIPTION OF THE DRAWINGS

FIG. 1 is a block diagram of a system for monitoring medication adherence, according to an example embodiment of the present invention.

FIG. 2 is a block diagram of an adherence monitoring service, according to an example embodiment of the present invention.

FIG. 3 is a flowchart that shows a method for monitoring medication adherence, according to an example embodiment of the present invention.

FIG. 4 shows a user interface by which a user accesses an adherence monitoring service, according to an example embodiment of the present invention.

FIG. 5 shows a user interface by which a user manually creates a non-adherence case, according to an example embodiment of the present invention.

FIG. 6 shows a user interface by which a user inputs medication information for a non-adherence case, according to an example embodiment of the present invention.

FIG. 7 shows a user interface by which a user inputs a case type for a non-adherence case, according to an example embodiment of the present invention.

FIG. 8 shows a user interface by which a user inputs detailed medication information for a non-adherence case, according to an example embodiment of the present invention.

FIG. 9 shows a user interface by which a user accesses an adherence rule menu for viewing and editing adherence rules, according to an example embodiment of the present invention.

FIG. 10 shows a user interface by which a user creates a new adherence category, according to an example embodiment of the present invention.

FIG. 11 shows a user interface by which a user creates a new adherence rule, according to an example embodiment of the present invention.

FIG. 12 shows a user interface by which a user inputs basic information for an adherence rule, according to an example embodiment of the present invention.

FIG. 13 shows another user interface by which a user inputs basic information for an adherence rule, according to an example embodiment of the present invention.

FIGS. 14 to 18 show user interfaces by which a user inputs information for configuring an adherence rule, according to an example embodiment of the present invention.

FIG. 19 shows a user interface that displays details of an open non-adherence case, according to an example embodiment of the present invention.

FIG. 20 shows a user interface that displays prescriber information for a non-adherence case, according to an example embodiment of the present invention.

FIG. 21 shows a user interface that displays provider information for a non-adherence case, according to an example embodiment of the present invention.

FIG. 22 shows a user interface by which a user accesses fill history information for a non-adherence case, according to an example embodiment of the present invention.

FIG. 23A to 23E shows user interfaces by which a user configures an alert scenario for generating notifications in response to triggering based on adherence rules, according to an example embodiment of the present invention.

FIG. 24 shows a user interface by which a user assigns adherence rules to work queues, according to an example embodiment of the present invention.

FIG. 25 shows a user interface by which a user accesses case information, according to an example embodiment of the present invention.

FIG. 26 shows a user interface by which a user updates a status of a non-adherence case, according to an example embodiment of the present invention.

FIG. 27 shows a user interface by which a user accesses a menu for viewing and editing notification templates, according to an example embodiment of the present invention.

FIG. 28 shows a user interface by which a user creates or edits notification templates, according to an example embodiment of the present invention.

FIG. 29 shows a user interface by which a user creates a notification template, according to an example embodiment of the present invention.

FIG. 30 shows a user interface by which a user configures a notification template, according to an example embodiment of the present invention.

FIG. 31 shows a user interface by which a user selects a placeholder variable for insertion into a template, according to an example embodiment of the present invention.

FIG. 32 shows a user interface that displays different placeholder variables, as they appear after being inserted into a document, according to an example embodiment of the present invention.

FIG. 33 shows a user interface that displays a list of potential placeholder variables, according to an example embodiment of the present invention.

FIG. 34 shows a user interface for assigning access privileges to users, according to an example embodiment of the present invention.

### SUMMARY

While conventional medication adherence monitoring involves tracking prescription fills using insurance claims, and a patient's prescription fill history may provide useful information regarding what types of medications the patient is taking and how often the patient is taking them, conventional monitoring does not take into consideration other sources of relevant information. Conventional monitoring also lacks the ability to quickly and automatically respond to instances of non-adherence. Often, manual review of non-adherence cases takes place long after the non-adherence event has occurred. Additionally, such conventional manual review is not aided by a workbench interface environment.

Example embodiments of the present invention provide a system and method for monitoring a patient's adherence to a prescribed medication. The system and method involve configuring adherence rules to detect various types of non-adherence situations. In addition to the missing fill situation mentioned in the background section, other types of non-adherence situations can be monitored. According to an example embodiment, additional non-adherence situations include medication overuse (e.g., overuse of opioids), formulary violations in which a non-preferred drug is taken instead of a plan sponsor's preferred medication, dosage changes, when a patient switches to a different medication, and violations with respect to related medications (e.g., medications used to treat comorbidities).

According to example embodiments, a system and method for monitoring a patient's adherence to a prescribed medication include obtaining prior authorization (PA) data that includes historical information relating to a PA request for one of the prescribed medication and a related medication. Analysis of PA data provides significant advantages over conventional methods, which are limited to analysis of claims. PA data provides an additional source of information that is useful in itself, and can also be used to supplement claims data in order to provide a more complete picture of a patient's medication history, e.g., by providing context to fill decisions that follow from PA requests.

According to example embodiments, a system and method for monitoring a patient's adherence to a prescribed medication include creating a rule that monitors a patient's adherence to a prescribed medication. As mentioned earlier, rules can be configured to detect any number of non-adherence situations, including insufficient use, overuse, dangerous interactions with other medications, and use of a non-preferred medication. Advantageously, the rule may be configured using user supplied criteria for defining a non-adherence condition. This allows custom rules to be created to suit the needs of various plan sponsors.

According to example embodiments, a system and method for monitoring a patient's adherence to a prescribed medication include assigning non-adherence cases for review by users of a system that monitors patient adherence to prescribed medications, through creation of work queues. Each queue may be associated with a different user role in the system, thereby allowing cases to be efficiently directed to appropriate reviewers by assigning the cases to the queues based on a processor determination of a relevancy of the case to each queue. According to an example embodiment, rules can be associated with queues such that triggering of the rules causes the resulting cases to be assigned to the respective associated queues. This allows the queues to be rule specific in addition to user role specific.

According to example embodiments, a system and method for monitoring a patient's adherence to a prescribed medication include generating a notification in response to a patient's non-adherence, using a notification template. The template generates a notification document and can be modified by inserting a placeholder variable into the template. The placeholder variable describes a parameter applicable to specific instances of non-adherence. This allows generic templates to be created, e.g., to fit specific non-adherence situations. When it is time to generate a notification document, details of a specific non-adherence case can be filled in by replacing the placeholder variable with an actual value of the parameter, e.g., from a stored record associated with the patient.

### DETAILED DESCRIPTION

Example embodiments of the present invention relate to a system and a computer-implemented method for monitoring a patient's adherence to a prescribed medication. The example system and method involve obtaining PA data that includes historical information relating to a PA request for a prescribed medication or a related medication, and then analyzing the PA data based on a rule to detect non-adherence with respect to the prescribed medication. For example, non-adherence may be defined as a failure to obtain the prescribed medication within a predefined time period after a PA request for the prescribed medication was approved. As will be explained, other types of non-adherence conditions exist such as taking too much of a prescribed medication (overuse, which may be detected based on a cumulative quantity of medication requested or obtained by the patient over a predefined time period). Rules may be created based on user input of criteria that define a non-adherence condition for each rule (e.g., failure to obtain a prescribed medication within a certain number of days, where the user identifies the medication and inputs the number of days).

According to an example embodiment, cases are opened in response to rule triggering and open cases are placed on queues for user review. Queues may be established for different user roles in the system. Queues may also be established for different types of non-adherence behavior. When a case is opened, the case is assigned to an appropriate queue based on a processor determination that the case is relevant to the queue (e.g., a case where the non-adherence behavior is a failure to obtain a prescribed medication may be assigned to a “missing fill” queue. After removing a case from a queue (i.e., in response to user reviews of the case), subsequent instances of non-adherence by the same patient and to the same prescribed medication at issue in the earlier case will result in the system assigning one of a new case and the same case to each queue from which the same case was previously removed. Whether a new case is assigned depends on if the earlier case was closed (a new case will be opened) or if the case was flagged for monitoring (the same case will be reopened).

According to an example embodiment, the system generates notifications to relevant parties in response to detection of non-adherence. The notifications may be automatically generated using user-configured templates. In an example embodiment, the templates include placeholder variables that describe a parameter applicable to specific instances of non-adherence, i.e., a case-specific variable such as the patient's name or address, the name of the medication, or a relevant quantity of medication. The notification is generated by obtaining an actual value for the parameter from a relevant record in the system and replacing the placeholder with the actual value.

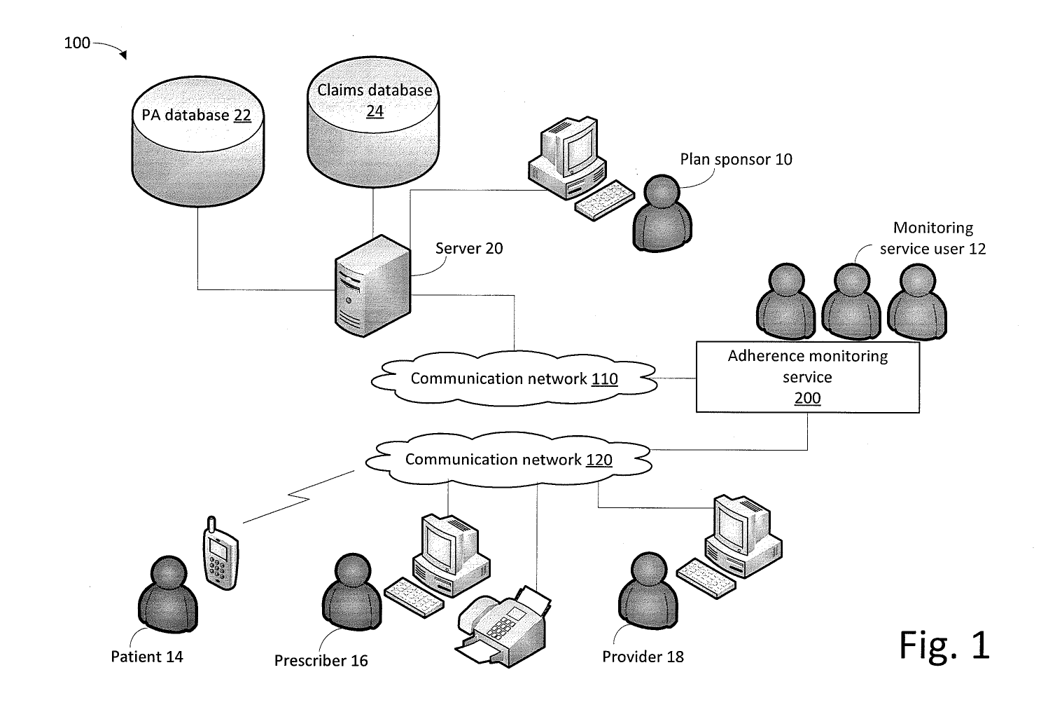

FIG. 1 shows a system 100 for monitoring medication adherence according to an example embodiment of the present invention. According to the illustrated example embodiment, the system 100 includes a server 20 operated by a plan sponsor 10 or an entity on behalf of a plan sponsor (e.g., a prescription benefit manager). A plan sponsor refers to an entity that provides a health insurance plan, which plan may be part of a public health insurance program such as Medicaid or Medicare or may be a private plan. The server 20 is configured to access a prior authorization (PA) database 22 and a health insurance claims database 24. The databases 22, 24 may be stored locally at the server 20 or may be remotely accessible.

The PA database 22 stores data pertaining to PA requests, which are requests for plan sponsor approval with respect to the plan sponsor's providing of coverage for a requested medical product or service, e.g., for a medication prescribed by a physician. The PA requests may be generated using a system for requesting prior authorization, such as that described in U.S. Pat. application Ser. No. 13/963,608 filed on Aug. 9, 2013 (“the '608 application”). The'608 application is incorporated by reference herein in its entirety. Example PA data includes a date on which a PA request was initiated, the name of the medication or service requested, an amount of medication requested, information identifying a prescribing physician, information identifying a provider of the requested medication/service (e.g., a pharmacy or hospital), information identifying the patient associated with a particular PA request, a date on which a decision was rendered for a PA request and the nature of the decision (e.g., approval or denial of the PA request).

The claims database 24 stores data pertaining to insurance claims filed by or on behalf of patients participating in a plan offered by the plan sponsor 10. Example claims data includes a date on which a claim was initiated, the name of the medication or service that was provided, information identifying a prescribing physician, information identifying a provider of the requested medication/service, information identifying the patient associated with a particular claim, and a date on which a decision was rendered for a PA request (e.g., approval or denial of the claim) and the nature of the decision (e.g., coverage in full, partial coverage or no coverage).

According to an example embodiment, the system 200 further includes an adherence monitoring service 200, which is connected to the server 20 through a communication network 110, such as the Internet. The adherence monitoring service 200 receives the PA data and the claims data from the server 20 over the network 110, e.g., via facsimile, email or other electronic data transfer. The PA and claims data may also be provided to the adherence monitoring service 200 in hard copy format, in which case the PA data or the claims data may be digitally converted, e.g., using optical character recognition. The adherence monitoring service 200 may receive PA and claims data from a plurality of plan sponsors 10 so as to provide adherence monitoring for each plan sponsor with respect to the patients of the respective plan sponsor. As will be explained, the adherence monitoring service 200 analyzes the PA and claims data against preconfigured rules to detect whether there are instances of non-adherence. When non-adherence is detected, the adherence monitoring service 200 is configured to perform an intervention process that involves contacting a notified party, e.g., a non-adhering patient 14 and/or someone involved in providing medical treatment to the non-adhering patient 14, e.g., a prescriber 16 or a provider 18. In an example embodiment, intervention includes sending notifications automatically in response to the detection of the non-adherence. Notifications can also be sent manually. Intervention may also involve telephone calls to the notified party.

According to an example embodiment, the adherence monitoring service 200 contacts the notified party through a communication network 120 to which a receiving device operated by the notified party is connected. According to an example embodiment, the adherence monitoring service 200 is configured to send notifications in a plurality of electronic formats to suit different receiving devices, such as mobile phones, personal computers and facsimile machines. As such, notifications may occur via email, text message, fax, etc. The adherence monitoring service 200 may also send paper notifications, e.g., a letter to the non-adhering patient's home address.

The adherence monitoring service 200 may be operated by any number of users 12, who may include medical professionals such as registered nurses or physicians. Users 12 may also include non-medical personnel such as customer service representatives who interact with the plan sponsor 10 (e.g., adherence specialists) and/or with the notified party, billing staff, data entry staff and technical support staff.

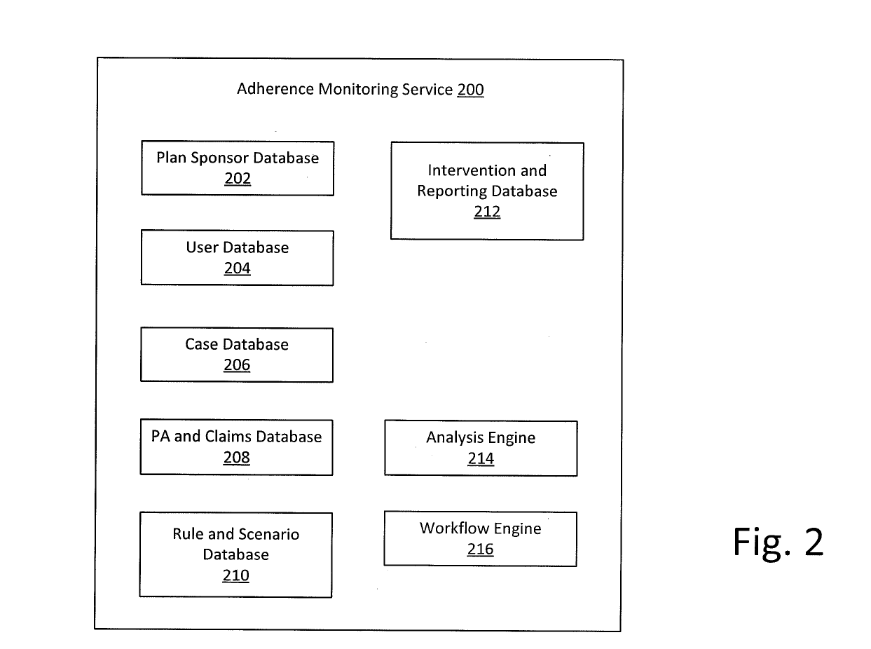

FIG. 2 is a block diagram of the adherence monitoring service 200 according to an example embodiment of the present invention. In the illustrated example, the adherence monitoring service 200 includes a plan sponsor database 202, a user database 204, a case database 206, a PA and claims database 208, a rule and scenario database 210, and an intervention and reporting database 212. The adherence monitoring service 200 also includes an analysis engine 214 and a workflow engine 216. Each of the engines 214, 216 can be implemented as software, including program instructions executed by a computer processor at the adherence monitoring service 200.

The plan sponsor database 202 stores data pertaining to each plan sponsor participating in monitoring. Example plan sponsor data includes billing records describing fees charged for the monitoring service, contact information for the plan sponsor, and access credentials allowing the plan sponsor to electronically access the adherence monitoring service 200, e.g., to view data pertaining to instances of non-adherence, billing records, or to submit PA data and claims data for analysis.

The user database 204 stores data pertaining to each user 12 of the adherence monitoring service 200. Example user data includes employee records, access credentials, and an identifier that indicates a user's role in the adherence monitoring service 200. User roles may, for example, correspond to any of the user categories mentioned earlier (e.g., registered nurse, physician or customer service representative).

The case database 206 stores data pertaining to instances of non-adherence, which data may be organized in the form of cases. Cases may be patient-specific and corresponds to one or more instances of non-adherence for a particular patient. Alternatively or additionally, cases may be medication-specific, corresponding to one or more instances of non-adherence with respect to a particular medication. Thus, a case may provide information about a particular patient's history of adherence or non-adherence with respect to a particular medication. Example case data includes dates on which the medication was filled (e.g., the last fill date), an identity of a provider who filled the medication, an identity of a prescriber of the medication, and dosage and quantity information.

Case data can also include information for alternative medications that perform similar functions, which medications are also the subject of a PA request, have been prescribed for the patient (e.g., for treatment of the same medical condition), or were purchased by the patient (as indicated by claims data). For example, a case may contain information for a brand name influenza medication together with information for a generic or over-the-counter influenza medication that was subsequently prescribed for the same patient.

Alternatively or additionally, case data can include information for medications that are contraindicated for use in conjunction with another medication of record in the case. Thus, the case data may indicate whether the patient is using medications that, when taken at the same time, are known to cause adverse health effects.

Case data can further include records of interventions performed in response to instances of non-adherence. For example, intervention records may include telephone call logs with summaries of calls to notified parties, copies of letters sent to the notified party, or notes authored by a user in connection with intervention activity.

The PA and claims database 208 stores PA data and claims data obtained from plan sponsors. The PA and claims database 208 can be implemented as a single database indexed, e.g., according to a patient identifier. Alternatively, the PA and claims database 208 can be implemented using separately indexed databases, e.g., by storing the PA data and the claims data separately, as described with respect to the arrangement in FIG. 1.

The rule and scenario database 210 stores rules according to which the data in the PA and claims database 208 are analyzed to detect non-adherence. In an example embodiment, the database 210 includes default rules that are applicable to all medications. For example, a default rule might be triggered in response to any instance of a missed fill greater than sixty days, e.g., “trigger if the number of days since the last fill is greater than sixty.” An example of a default rule involving the use of PA data is “trigger if the patient's PA request was approved and no fill has occurred within X days of granting the PA request.” Another example is “trigger if the patient's PA request was denied and the patient has not initiated another PA request or claim, for an alternative medication, within X days of denying the PA request.”

The system is also configured for the rule database 210 to include customized rules created by user modification of an existing rule (e.g., a default rule) or user creation of a new rule. An example of a customized rule is what is referred to herein as a formulary rule, which detects whether the patient is taking a preferred medication in a plan sponsor's drug formulary. Formulary rules may be triggered when the patient requests prior authorization or insurance coverage for a non-preferred, a lesser-preferred, or a non-formulary medication. The database 210 can further include preconfigured rules for monitoring in accordance with existing guidelines, e.g., rules that implement the monitoring procedures required by the CMS rating system. An example of a CMS rule that detects opioid overuse is “trigger if the patient exceeds X number of PA requests for opioid medications within the last Y days, or if the number of days since the last fill of an opioid medication is less than Z days.”

In addition to rules, in an example embodiment, the database 210 stores alert scenarios, which describe conditions under which a rule triggering will result in generating a notification, possibly in association with a template for generating the notification. Scenarios may be created to address different non-adherence situations, e.g., a missing fill or a formulary violation. Scenarios may also be plan sponsor specific.

The intervention and reporting database 212 stores data for use in performing interventions. For example, in an example embodiment, the database 212 includes templates for generating letters to notified parties. As will be explained, notifications can be populated with placeholder variables that correspond to data pertaining to a subject case, such as the patient's name, the prescriber's name, the medication name and quantity, and the last fill date. Accordingly, in an example embodiment, the database 212 stores a list of placeholder variables that are selectable for inclusion in notifications. In an example embodiment, the database 212 also stores templates for generating reporting letters that summarize cases for each plan sponsor. The content of the reporting letters may vary depending on whether the recipient of the reporting letter is the plan sponsor or a third party. For example, the reporting letter may be more detailed when the recipient is the plan sponsor, as compared to when the recipient is the third party (e.g., CMS).

The analysis engine 214 performs adherence monitoring by analyzing the data in the PA and claims database 208 according to the rules in the rule and scenario database 210. The analysis can be performed in response to the creation of a new rule, modification of an existing rule, or receipt of new PA or claims data. Alternatively or additionally, analysis can be performed at predetermined intervals in accordance with time periods specified by the rules. A rule may specify a time window relative to the last fill, outside of which window the rule is triggered. For example, if a prescribed medication is refilled before the beginning of the window, this may indicate that the patient is taking too much of the prescribed medication. Similarly, if the prescribed medication or an alternative medication is filled after the window, this may indicate that the patient is not taking enough of the prescribed medication and not seeking alternative treatment. Therefore, the analysis engine 214 may be configured to execute the rule at least twice for each applicable medication: once before the beginning of the window and once after the end of the window.

The workflow engine 216 assigns cases to the users 12 for review. Cases may be assigned using queues, each queue being associated with one or more user roles. For example, customer service representatives may have a dedicated queue for handling non-adherence cases that do not require medical analysis, while nurses may have a separate queue for handling non-adherence cases that involve certain types of medications. Example queus associated with user roles include queues for customer service, an adherence specialist, a pharmacist, a nurse and a medical director. The queues may be operated on a first-in-first-out basis, with cases being taken off the queue when a user has finished reviewing the case. The workflow engine 216 may allow users to handle cases out of order, e.g., by selecting urgent cases for review that are not at the head of the queue. It is possible that cases may be assigned to more than one queue simultaneously because certain cases may be appropriate for review by more than one user role. The workflow engine 216 may coordinate the handling of such cases by making sure that a case which has been removed from a queue does not remain on any other queue. Cases may be removed by updating their status, e.g., by closing the case or flagging the case for continued monitoring.

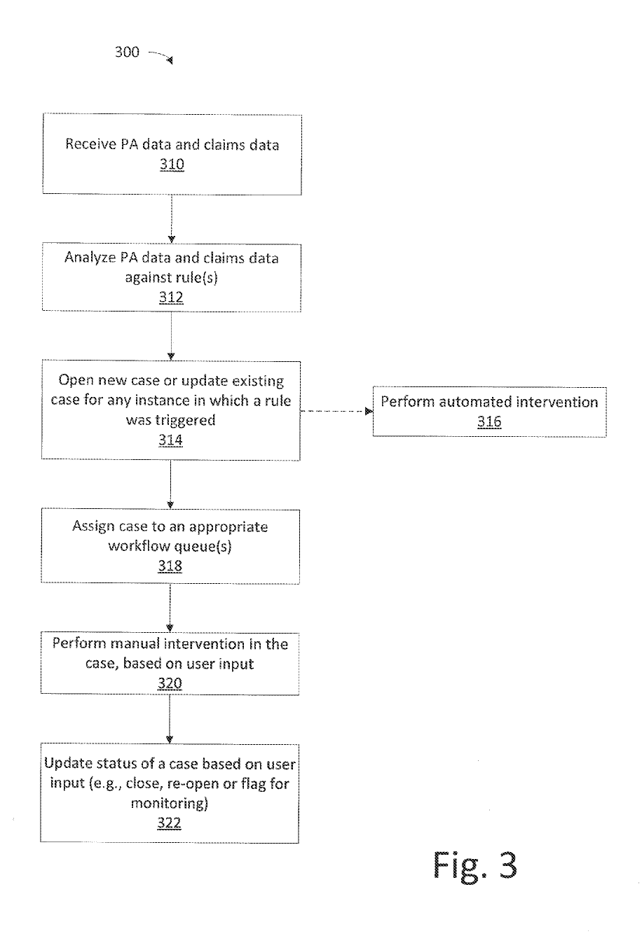

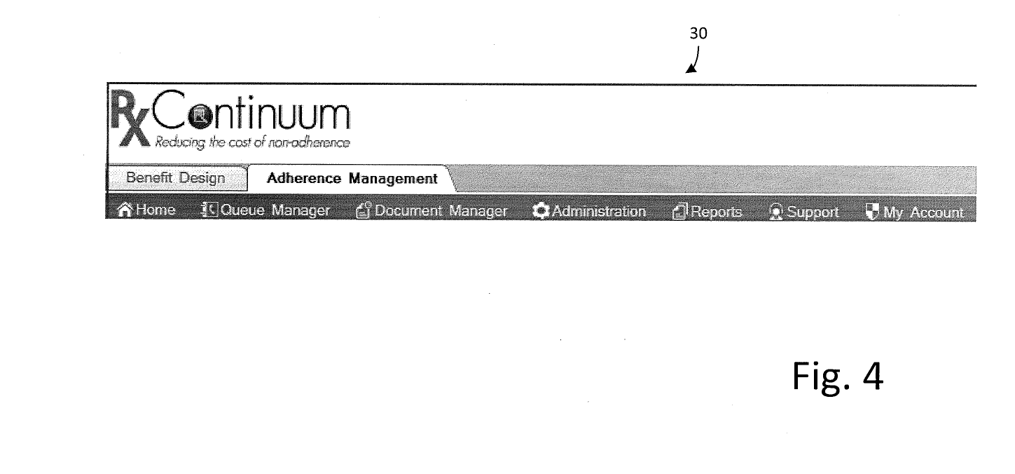

FIG. 3 is a flowchart of a method 300 for monitoring medication adherence according to an example embodiment of the present invention. According to an example embodiment, the method 300 is implemented using graphical user interface (GUI) screens for interacting with the adherence monitoring service 200, example of which are shown in FIGS. 4 to 34. According to an example embodiment, the method 300 can be performed using the system 100.

At step 310, PA data and claims data is received at the adherence monitoring service 200. For example, in an example embodiment, the server 20 is configured to automatically transmit this data. The plan sponsor 10 can also provide this data manually.

At step 312, the PA data and claims data are analyzed according to the rules in the rule database 210 to detect whether there are any instances of non-adherence. If non-adherence is detected, the rule is triggered and the method proceeds to step 214. Otherwise, the method ends at step 312.

At step 314, a new case is opened or an existing case is updated in response to triggering the rule. New cases may be created, for example, in response to an initial instance of non-adherence with respect to a particular patient and/or a particular medication. A new case may also be created if the existing case is closed at the time of a subsequent non-adherence. An existing case may be updated if the case remains open at the time of the subsequent non-adherence, or has been closed but flagged for continued monitoring.

At step 316, an automated intervention is performed in response to the opening/updating of the case in step 314. Automated interventions are optional and may involve generating a notification, e.g., a letter or fax, using a template stored at the intervention and reporting database 212. Notifications are generated in response to triggering of alert scenarios, similar to how cases are opened in response to rule triggering. The notification may state facts underlying the non-adherence and recommend a course of action such as refilling the medication, contacting the patient to obtain further information, seeking medical advice, switching to a preferred formulary medication, not to resume taking a medication because the patient has been off the medication for too long, and gradually resuming the medication through stepped dosages. Automated interventions may be followed by a manual intervention when the case is subsequently reviewed by a user.

At step 318, the case is assigned to an appropriate work queue. In an example embodiment, the system is configured for associating rules with one or more user roles, which are in turn linked to one or more queues, so that, when the rule is triggered, the resulting case is therefore be assigned to the queues of the associated user roles. If the case is already queued (e.g., in response to a previous triggering of the same rule or a triggering of another rule pertaining to the same medication), the workflow engine 216 may update the case data to reflect the triggering, without adding the case to the queue. Alternatively, the workflow engine 216 may move the case earlier in the queue because repeated triggering of the same rule or triggering of related rules may indicate that this is a case that requires urgent attention.

At step 320, a user associated with the open case (i.e., a user with access to a queue in which the case has been placed) may perform a manual intervention by providing comments on facts pertaining to the case, providing suggestions for follow up actions to be taken, initiating a telephone call to a notified party, and drafting a notification (e.g., using a notification template or as a new document).

The system is configured for the status of a case be updated, at step 322, based on user input. For example, an open case may be closed to indicate that no further interventions are planned. Cases may be closed where, for example, an intervention has been performed and the patient resumed adherence following the intervention. Closing a case results in removal of the case, by the system, from any queues that the case is currently in. Cases may be reopened manually (i.e., not in response to rule triggering) where, for example, a user discovers that an intervention was insufficient or the user wishes to add notes or perform another intervention in a closed case. Cases may also be flagged for monitoring, meaning that the case is closed, but a subsequent triggering of the same rule will reopen the flagged case instead of generating a new case, possibly resulting in further interventions. According to an example embodiment, the system is configured to de-queue flagged cases, similar to fully closed cases, because no actions are required on the part of the users when a case is flagged.

Example UIs will now be described. The example UIs may be provided to users of the adherence monitoring service 200, including the users 12 and the plan sponsor 10. The UIs may be provided through a web portal, which can be accessed by supplying valid user credentials. Alternatively, the UIs may be provided through software executed locally at the user's computer.

FIG. 4 shows an example UI 30 that includes a navigation menu for users 12 as well as plan sponsor users of the adherence monitoring service 200. The UI 30 provides a common interface through which any authorized user can access the adherence monitoring service 200. The UI 30 includes a Home option, a Queue Manager option, a Document Manager option, an Administration option, a Reports option, a Support option and a My Account option. Not all menu options are applicable to all users. For example, the Support and My Account options may only be applicable to plan sponsors. Options that are inapplicable to the current user may be disabled.

The Home option refreshes the UI to a default display screen (not shown). The Queue Manager option allows access to queues associated with the current logged-in user. The Document Manager option allows access to documents associated with the current user (e.g., notifications authored by the user, documents attached by the user in association with a particular case, and/or documents/notifications that have been sent in association with a case assigned to the user). The Administration option allows access to a rule configuration interface for creating or modifying rules. The Reports option allows access to case reports (e.g., CMS compliance reports). The Support option allows access to technical support or customer service, e.g., if the plan sponsor user has questions regarding his or her account or questions regarding how to access or navigate any of the UIs.

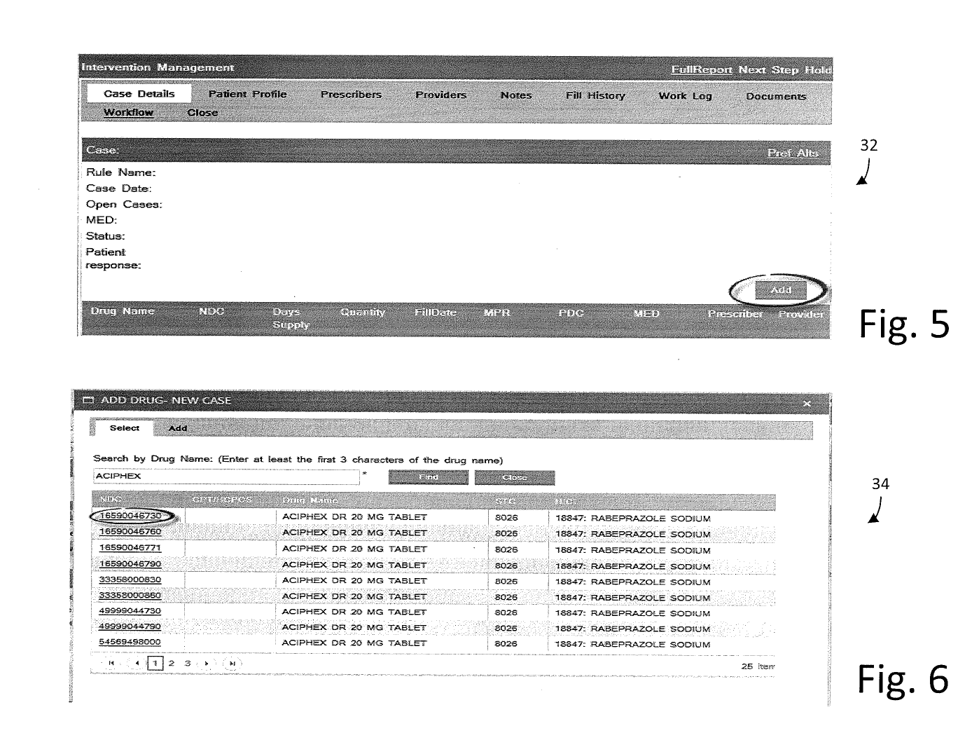

FIG. 5 shows an example UI 32 for manually creating a new case, in contrast to the rule-triggered case creation described earlier. However, the descriptions of case data which follow may be equally applicable to rule-triggered cases. The UI 32 includes Case Details, Patient Profile, Prescribers, Providers, Notes, Fill History, Work Log, and Documents options. FIG. 5 shows an example of a new case that has not yet been provided with parameters. As shown, case data may include an associated rule (identified, e.g., by a rule name), a list of a date on which the case was opened (or reopened), a list of open cases, an associated medication, a status (e.g., open, closed or flagged for monitoring), and a patient's response to a previously performed intervention (e.g., “patient plans to refill medication” or “patient refuses to take medication”). The UI 32 includes an Add option for manually creating a new case.

Selecting the Add button in FIG. 5 refreshes the UI to display the UI 34 in FIG. 6. The UI 34 includes a search option to search for a medication in a drug database, to associate the medication with the newly created case.

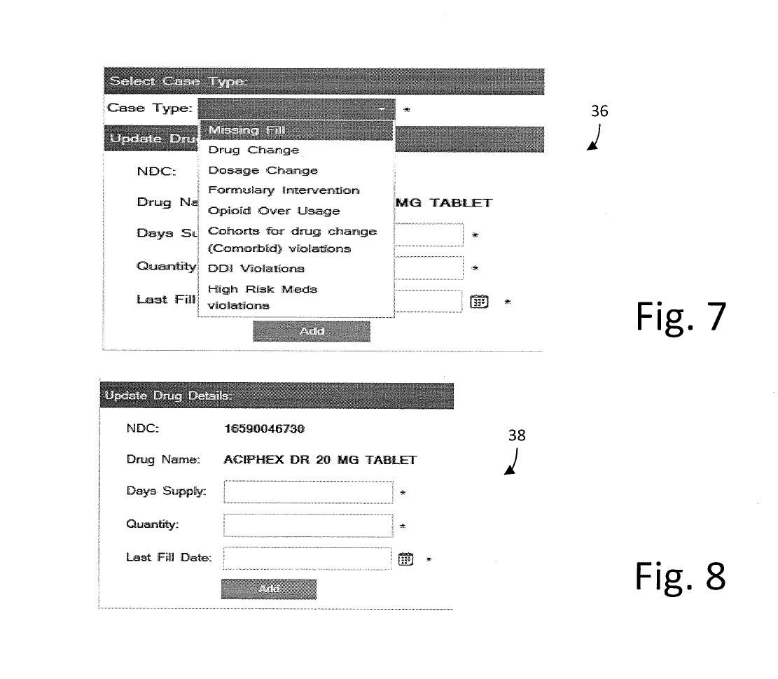

FIG. 7 shows an example UI 36 for assigning a case type to the newly created case. Case types characterize the non-adherence behavior at issue. When a case is opened in response to rule triggering, the case type is automatically assigned by the system based on the rule that was triggered. For example, a rule configured to detect missing fills may result in assignment of a “missing fill” case type. Other example case types include drug change, dosage change, formulary intervention, opioid over usage (when the subject medication is an opioid drug), cohorts for drug change, comorbid violations (instances of non-adherence relating to medical conditions that are comorbid with a health condition treated by the subject medication), Drug-Drug-Interaction (DDI) violations and high risk medication violations (when the subject medication is classified as having a high risk of adverse health effects). When cases are manually created, the case type may be manually assigned by selecting from a list of valid case types.

FIG. 8 shows an example UI 38 for specifying or updating details for a subject medication associated with a case. The UI 38 includes fields for supplying quantity information, days supply information and a last fill date.

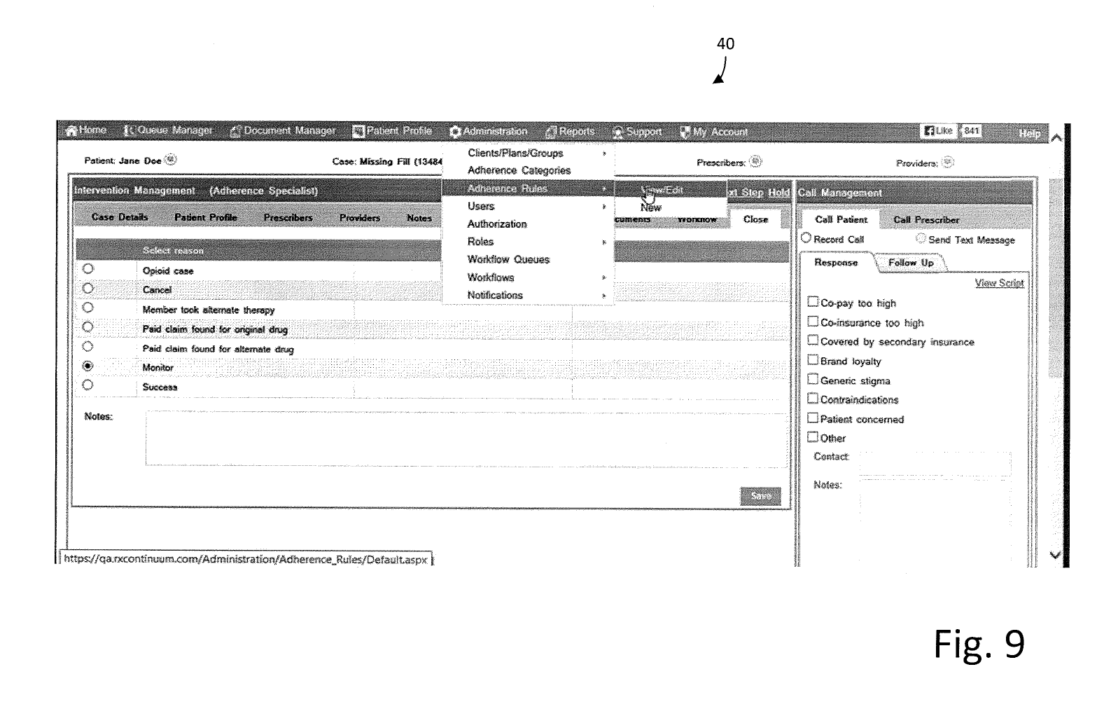

FIG. 9 shows an example UI 40 that includes a dropdown menu displayed in response to selecting the Administration option in FIG. 4. The dropdown menu includes options for accessing further menus relating to plans offered by the plan sponsor user, adherence categories, adherence rules, users, prior authorization, roles assigned to the users, work queues, workflows (e.g., a log of case review and intervention activity) and notifications. One of the dropdown options is for accessing an Adherence Rules submenu that allows for viewing and editing of an existing rule, in addition to creation of a new rule.

FIG. 9 also shows an example intervention management window and an example call management window, both of which are displayed when an adherence specialist user has selected a case for review. In the intervention management window, there are options to view case details, a patient profile, prescriber information, provider information, case notes, case documents, case workflow (e.g., intervention history). The status of the case may be updated through the intervention management window. The system is configured to facilitate the closing of cases, for which the system outputs a list of user-selectable reasons such as the patient taking an alternate therapy, a paid claim was later found for the subject medication (meaning the patient actually took the medication), a paid claim was later found for an alternative medication, or flagging the case for monitoring.

The example call management window includes options to place a call (e.g., using voice-over-IP) to a patient or prescriber, or to send a text message to the patient. The system provides an option for recording calls for storage in association with cases. The call management window includes options for noting a response, from the notified party, to an intervention. For example, when the notified party is the patient, responses may include reasons why the patient didn't fill the medication (e.g., co-pay too high, co-insurance too high, patient was covered for the medication by a secondary insurance, brand loyalty to a different brand of medication, generic stigma (where the subject medication is a generic drug), contraindications, or general patient concern). The call management window may also provide similar options for noting responses provided in connection with a follow up intervention.

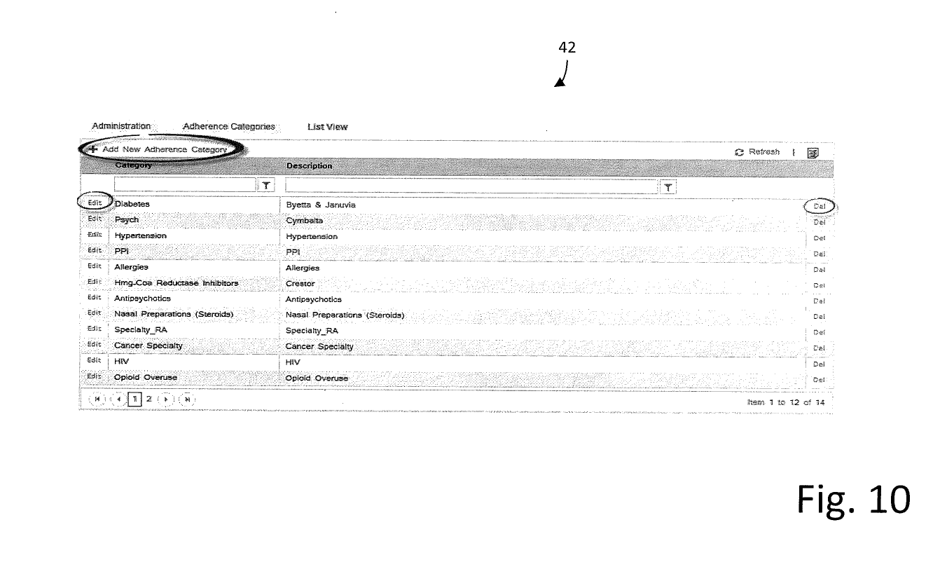

FIG. 10 shows an example UI 42 for creating and editing adherence categories. According to an example embodiment, adherence categories include specific medical conditions such as diabetes, psychological conditions, hypertension, allergies or HIV. Adherence categories may also include specific types of drugs such as proton-pump inhibitors (PPIs), HMG-CoA Reductase inhibitors, antipsychotics, nasal preparations (steroids in particular), cancer medications, or opioids.

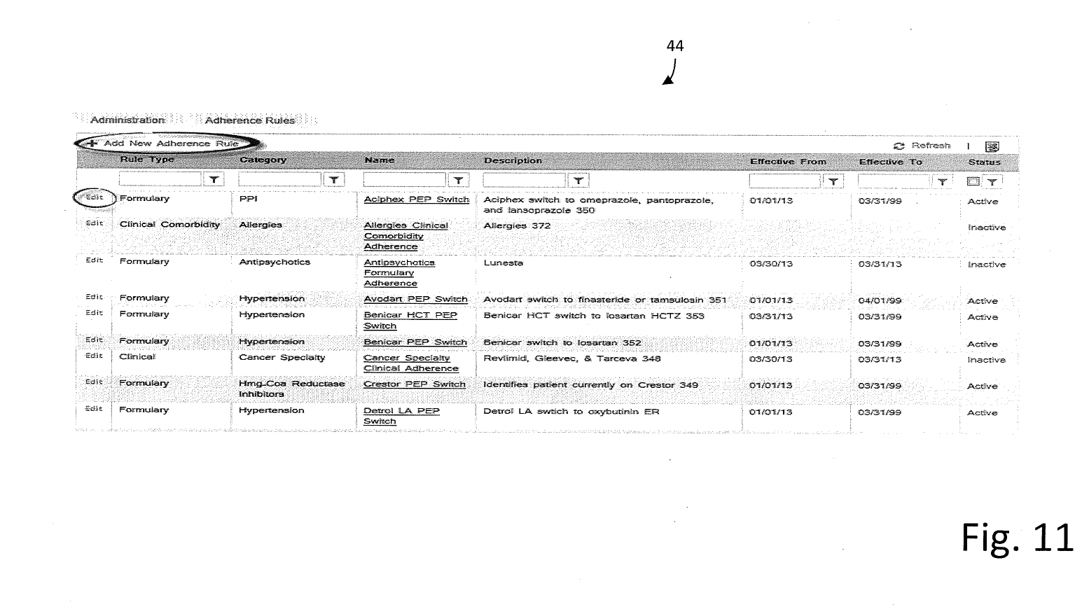

FIG. 11 shows an example UI 44 that lists adherence rules, which can be selected for editing of adherence rules, and that includes a selectable component for creating an adherence rule. As shown in FIG. 11, in addition to the adherence category, rules may be assigned a rule type (e.g., formulary or clinical comorbidity.), a name, a text description (which may include the names of each medication associated with the rule), a validity period (effective dates for which PA and claims data may be analyzed against the rule), and a current status (active or inactive). Whereas adherence categories characterize the specific medical conditions or medications at issue, rule types characterize the non-adherence behavior at issue. As mentioned earlier in connection with FIG. 7, case types may be assigned based on the rule that was triggered. More specifically, the assignment of case types is based on rule type. For example, a “formulary” rule type may result in a case type of “formulary intervention” and a rule type of “clinical comorbidity” may result in a case type of “comorbid violations.”

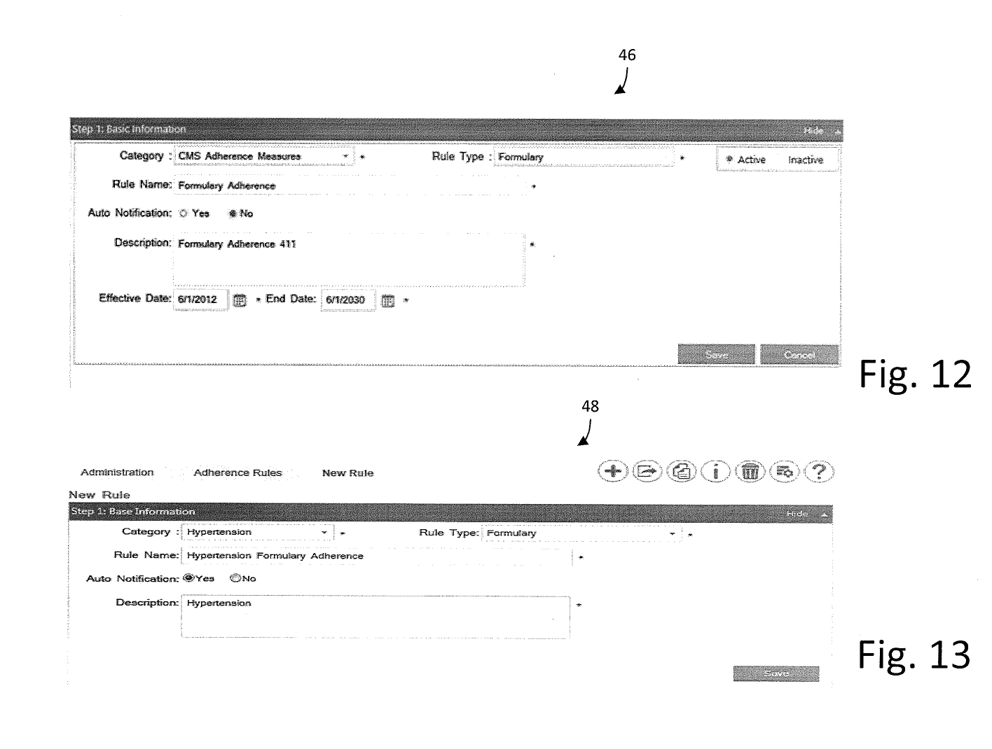

FIG. 12 shows an example UI 46 for assigning the previously described parameters to a rule (i.e., assigning the adherence category, rule type, name, status, description, effective date and status), and for specifying whether a user is to receive an automated notification whenever the rule is triggered. In FIG. 12, the rule is for monitoring a formulary medication in connection with CMS adherence measures. The UI 46 may be displayed when editing a rule that has previously been created.

FIG. 13 shows another example UI 48 for assigning the previously described parameters to a rule. In this instance, the rule is for monitoring adherence to a formulary medication used to treat hypertension. No effective date has been specified because the rule is newly created and therefore the effective date has yet to be assigned. In contrast, the rule in FIG. 12 was previously created so that certain parameters such as the effective date were already assigned.

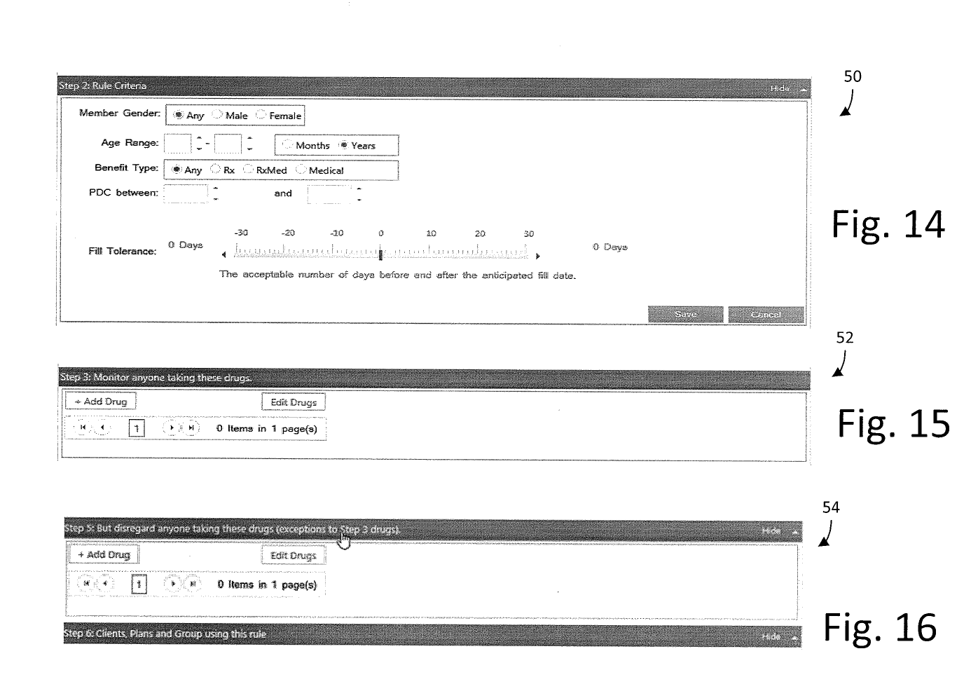

FIG. 14 shows an example UI 50 for specifying criteria for configuring a rule. Rule criteria may include patient gender, patient age range, benefit type (e.g., prescription, medical, or both), Percentage Based Coverage (PBC) range (PBC range is a patient's percentage of coverage under the plan in which the patient is enrolled), and fill tolerance (i.e., the time window described earlier). For example, if the user enters an age range, then the rule is triggerable only in connection with patients who are of an age that is within the specified range.

FIG. 15 shows an example UI 52 for positively associating medications with a rule. Positively associated medications are those medications for which corresponding PA and claims data will be analyzed to determine whether the rule is triggered. FIG. 16 shows an example UI 54 for negatively associating medications with a rule. Negatively associated medications are those that are not taken into consideration for determining whether the rule is triggered. PA and claims data corresponding to negatively associated medications are disregarded during analysis. Negative associations are useful where a subset of less than all of the positively associated medications is of interest. For example, if the rule is intended to monitor type-2 diabetes medication adherence, a positive association may be used to include all diabetes medications, while a negative association may be used to exclude non-oral diabetes medications (e.g., injectable insulin, which is used to treat type-1 diabetes). Each rule may be positively associated with at least one medication. However, there is no limit to the number of medications that can be associated with any particular rule. FIGS. 15 and 16 also show navigation bars with arrow icons for navigating through a list of positively or negatively associated medications. Since no medications have been added yet, the navigation bars show “0” items. Because each rule may be associated with numerous medications, it may not be possible to display an entire list on a single screen. Therefore, the lists may be displayed in a paginated format, with page “1” shown as the initial page.

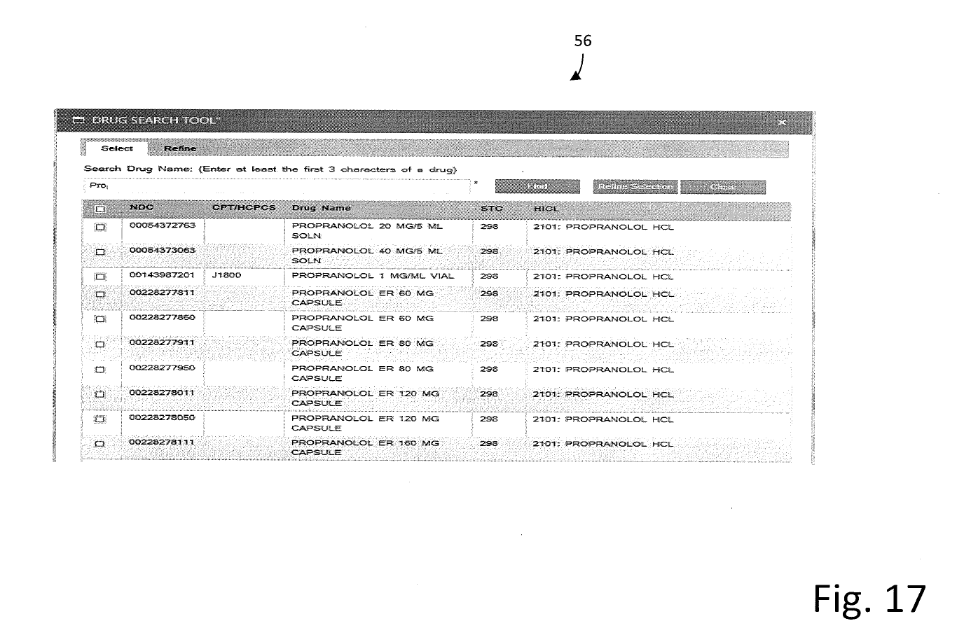

FIG. 17 shows an example UI 56 that allows for searching of a medication database, e.g., by drug name or National Drug Code (NDC). The UI 56 may be used, for example, in connection with selecting a medication for positive or negative association with a rule.

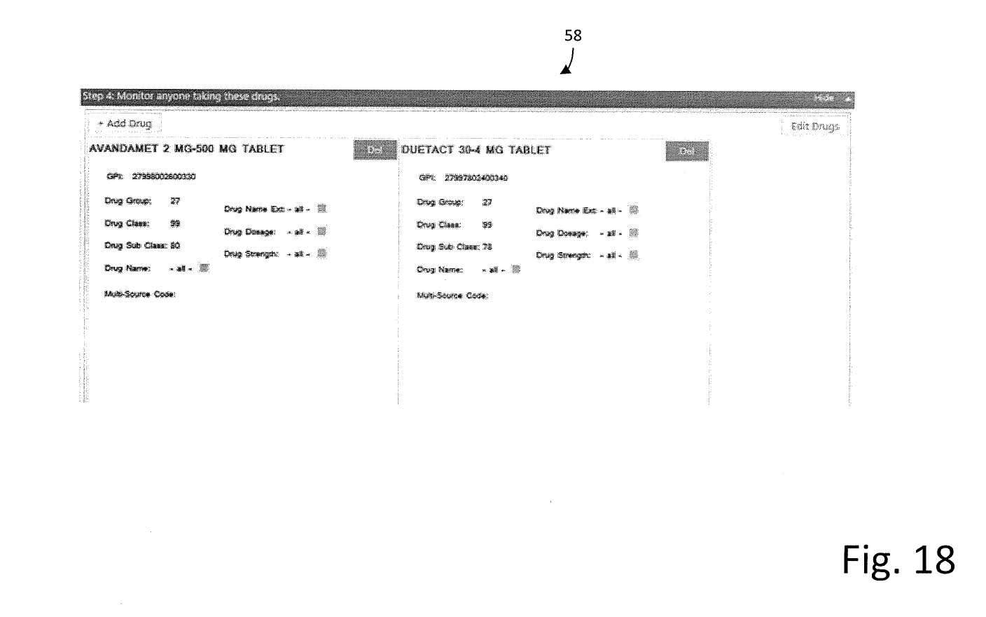

FIG. 18 shows an example UI 58 displaying a rule which has been associated with two medications used for treating type-2 diabetes, “Avandamet” and “Duetact.”

FIG. 19 shows an example UI 60 displaying details of an open case. In contrast to the parameters which had not yet been provided in FIG. 5, at least some of the parameters have now been filled in.

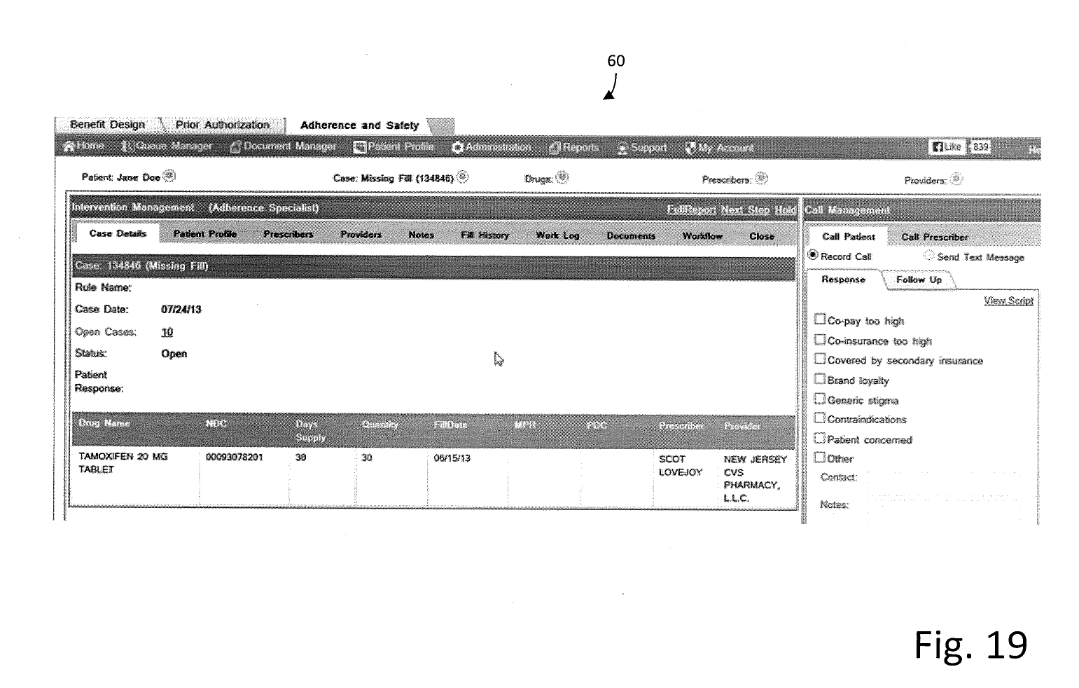

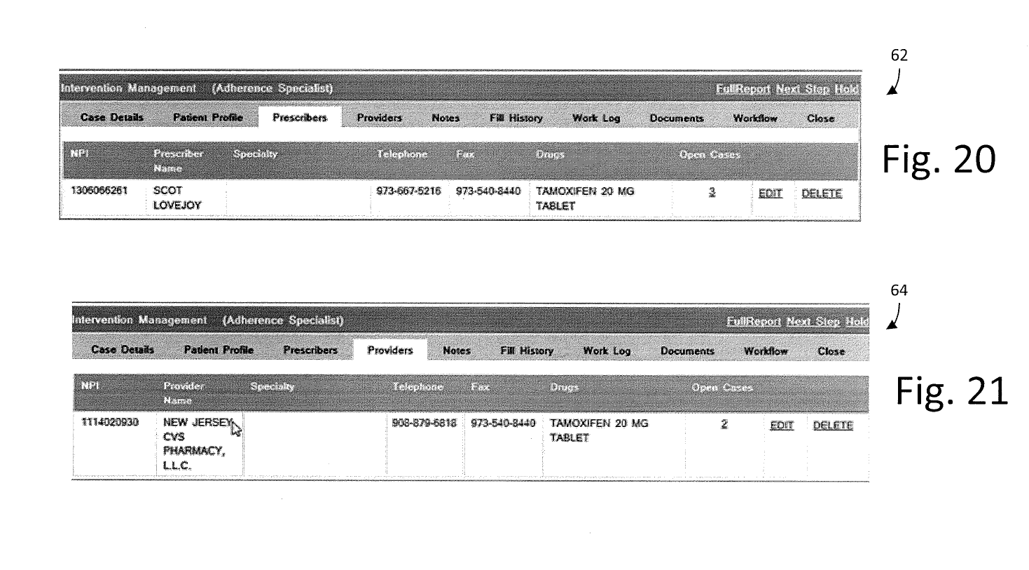

FIG. 20 shows an example UI 62 displaying prescriber information associated with an open case.

FIG. 21 shows an example UI 62 displaying provider information associated with an open case.

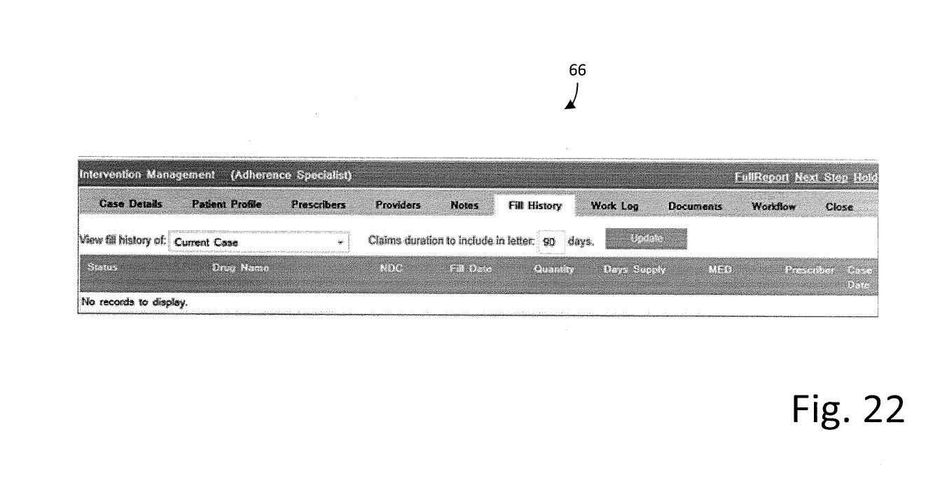

FIG. 22 shows an example UI 66 displaying a fill history associated with an open case. The UI 66 may also be used to access fill histories for other cases (regardless of status). Fill histories may be filtered by time (e.g., fill activities within a specified time period).

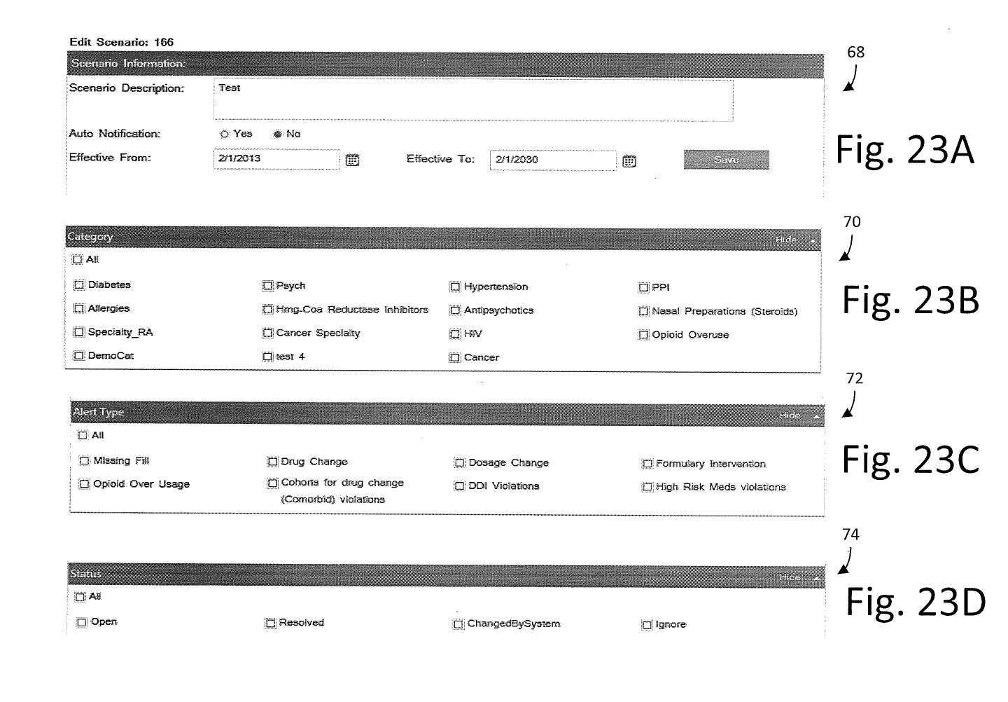

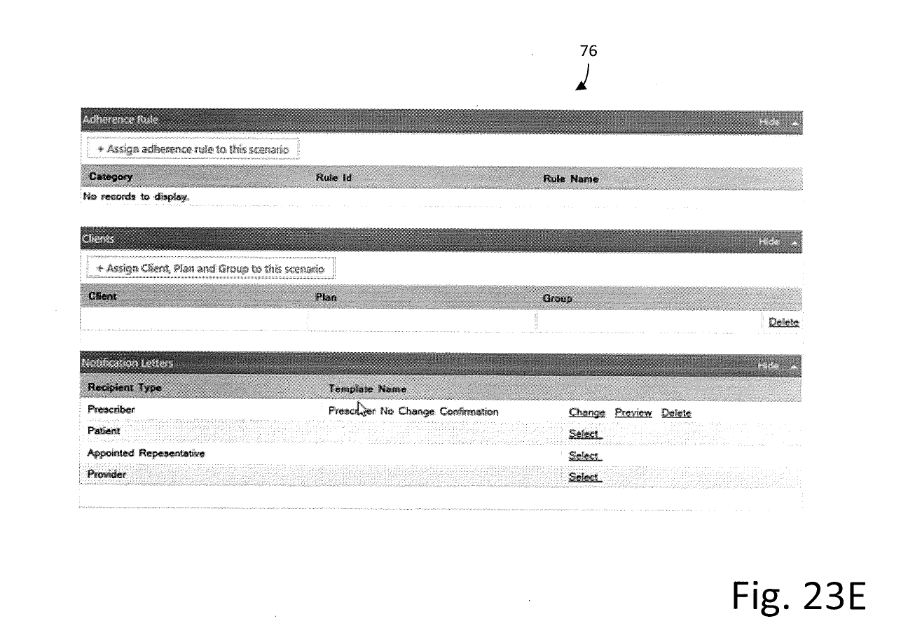

FIGS. 23A to 23E show example Uts 68 to 76 for configuring alert scenarios that generate notifications in response to triggered rules. According to an example embodiment, scenarios are data objects that describe the conditions under which notifications are generated (e.g., the rules to be triggered, the adherence categories that are involved, the plan sponsors for which to generate the notifications, etc.) in association with corresponding notification documents. Whereas rules cause the opening and queuing of cases, scenarios cause the automatic generation of notifications in response to the triggering of rules, because not every rule triggering warrants a notification. For example, notifications may only be appropriate where a plan sponsor has requested notification, for a specific adherence category, and/or for a specific group of patients.

As shown in the example UI 68 of FIG. 23A, scenarios may be assigned an effective date and an auto-notification preference, similar to how these parameters were assigned to a rule in FIG. 12. FIG. 23B shows an example UI 70 for assigning adherence categories to a scenario, similar to how adherence categories were assigned to a rule in FIG. 10. FIG. 23C shows an example UI 72 for assigning alert types to a scenario. The alert types are analogous to the case types in FIG. 7. FIG. 23D shows an example UI 74 for specifying what cases should be considered for sending notifications, e.g., open cases, resolved (closed or flagged) cases, and cases where the status was changed automatically by a computer of the adherence monitoring service rather than through user input (e.g., cases that were closed because they remained in the queue too long, or cases that were automatically determined to be adhering based on processing of subsequent PA or claims data).

FIG. 23E shows an example UI 76 for assigning an existing rule to a scenario. The UI 76 further allows for assigning a particular client (e.g., the plan sponsor 10), a health plan, or a group (a subset of less than all patients associated with a particular client) to a scenario. The result is that the particular client will be informed (e.g., via instant electronic notification or a summary report at the end of a reporting cycle) of any activity related to the scenario. The UI 76 further allows for assigning notification templates to a scenario, in association with specific notified parties. A separate template may be assigned for each notified party (e.g., one for each of the patient, the prescriber, a patient's appointed representative, and the provider). However, the same template may be reused for different parties. Templates may also be customized for particular clients, e.g., so that notifications include client logos.

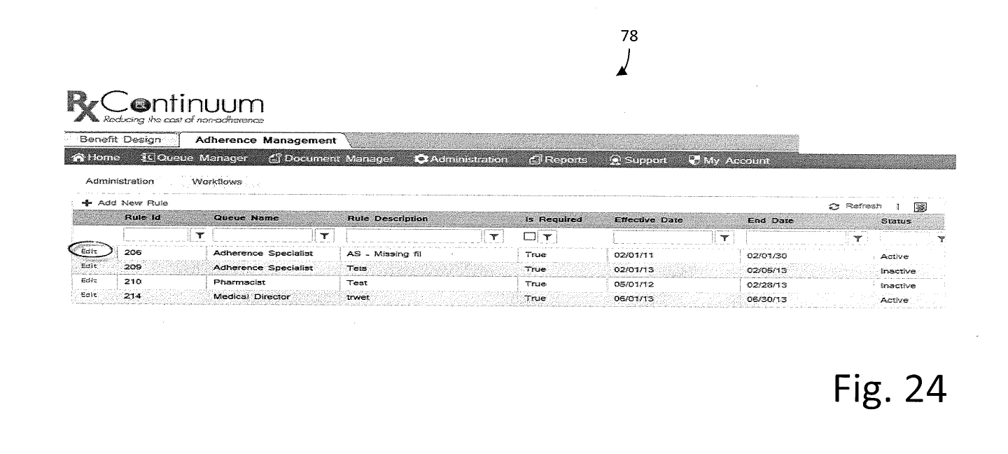

FIG. 24 shows an example UI 78 for assigning rules to queues. Cases resulting from triggering of a specific rule will automatically be placed on the queue(s) to which the rule has been assigned. The assigned rules may be active or inactive. Inactive rules do not produce queue activity, but may be reactivated at any time. Additionally, queues may be established for different case types. In an example embodiment, queues exist for each aforementioned case type. For example, the system may include a formulary cases queue, a dosage change cases queue, a drug change cases queue, a missing fill cases queue, an opioid alert cases queue, and a follow-up cases queue. Whenever a case is opened, the case will automatically be placed on the queue corresponding to the case type.

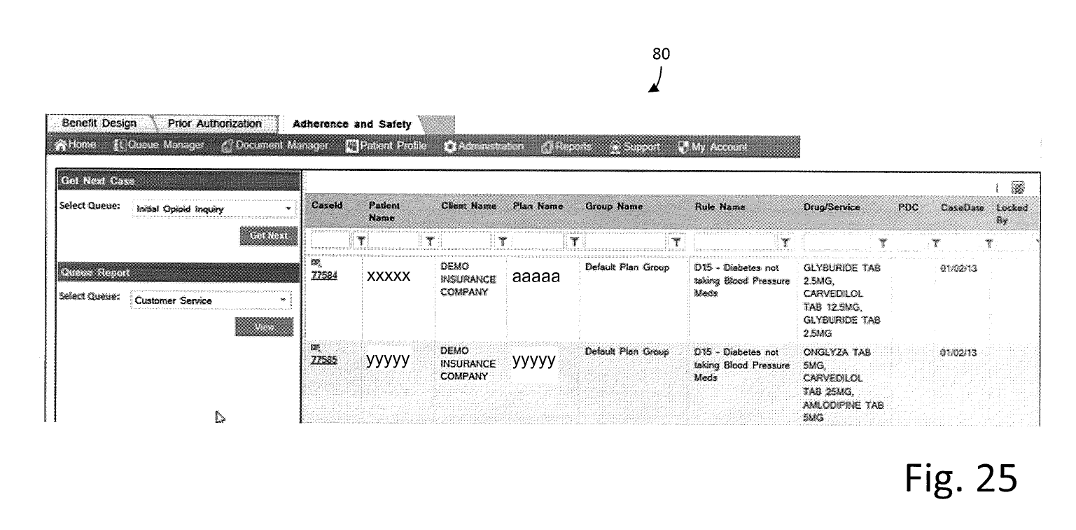

FIG. 25 shows an example UI 80 for viewing a queue and accessing case data from the queue. The UI 80 includes an option to get the next case for review and an option to view a summary report for a queue to which the user has been granted access. As shown on the right hand side of the UI 80, the contents of a selected queue may be displayed in a summary fashion in a window sized to fit the user's display. The contents may be displayed in queue order and may be sortable, e.g., according to any of the displayed case parameters, such as case ID, patient name, client (plan sponsor) name, group name, and rule name.

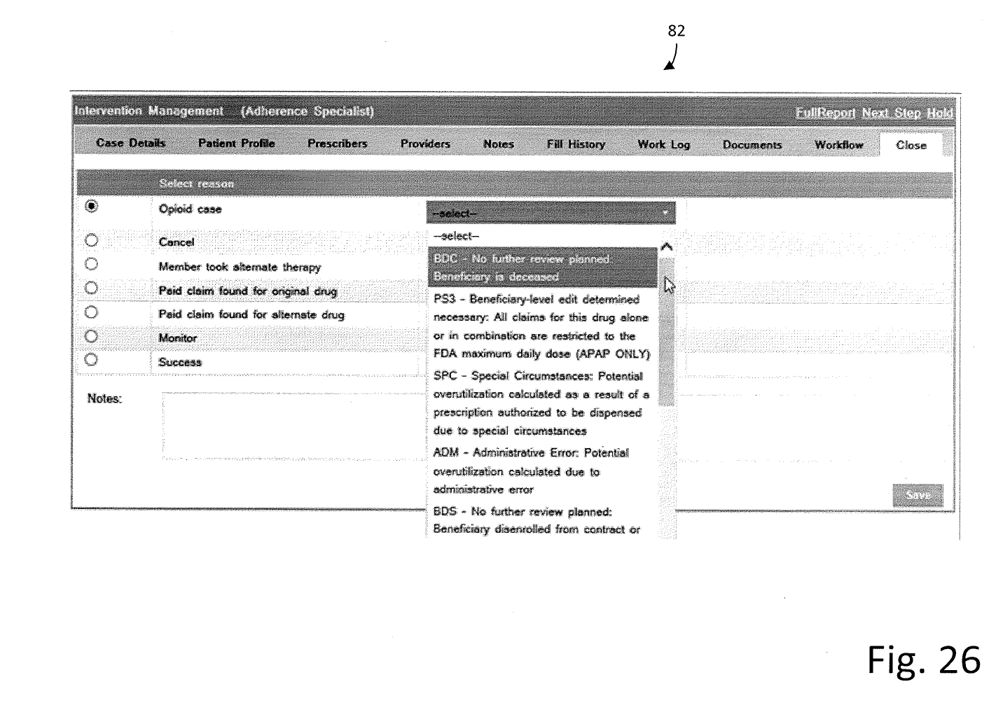

FIG. 26 shows an example UI 82 for updating a status of a case. The UI 82 is an expansion of the intervention management window in FIG. 9. As shown in FIG. 26, selecting a reason for closing the case may result in display of an additional menu of detailed reasons for further describing the circumstances surrounding the closing.

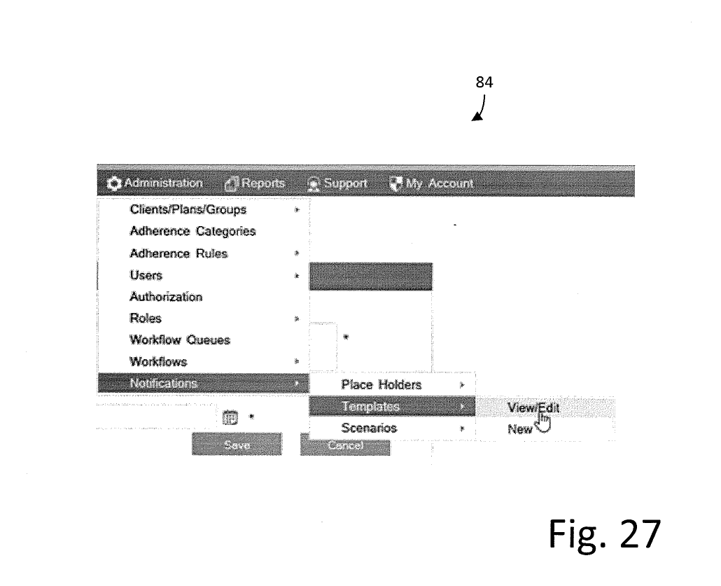

FIG. 27 shows an example UI 84 for accessing notification templates. The UI 84 is an expansion of the Administration option in FIG. 4 and includes a submenu for accessing notification templates, scenarios and placeholder variables.

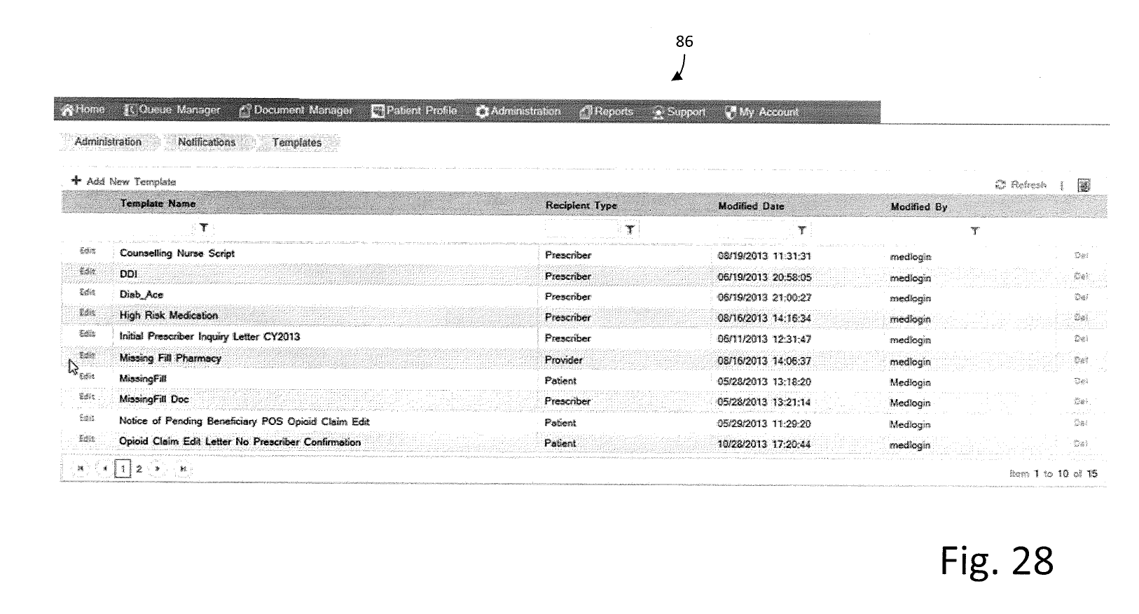

FIG. 28 shows an example UI 86 for creating and editing notification templates. As mentioned earlier, each template may be assigned to a notified party(ies) who is the recipient of a notification generated using the template. The templates may be displayed in order, sorted by, e.g., name, recipient type, modification date or author.

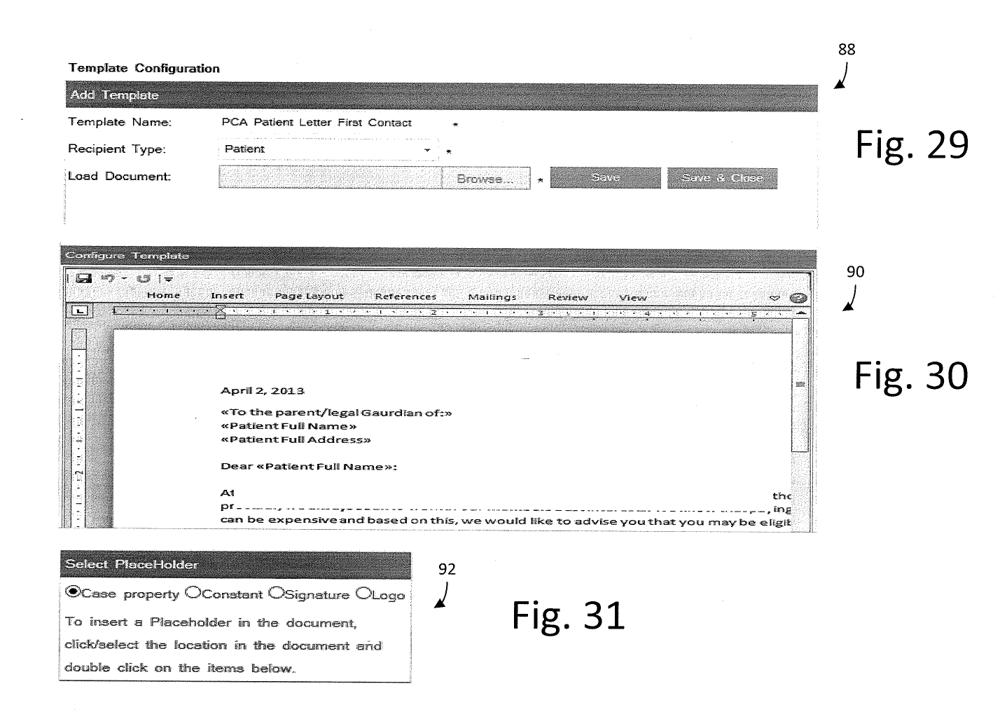

FIG. 29 shows an example UI 88 for creating a new template. Templates may be created, for example, by modifying existing templates or by loading a previously generated notification document.

FIG. 30 shows an example UI 90 for configuring a template. The contents of the template are displayed in a word-processing window including menus for inserting text or graphical elements (e.g., placeholder variables or special characters), changing the page layout, and previewing the notification.

FIG. 31 shows an example UI 92 for selecting a placeholder variable for insertion into a template. Placeholder variables may be used to personalize notifications for each case for which a template is instantiated, drawing upon the relevant record to obtain the particular relevant information. For example, a “Prescriber FullName” variable may be used to obtain the prescribers name from a relevant record and to insert the prescriber's name into a notification document. The prescriber's name is an example of a case property because it describes a parameter that is specific to a case. In addition to case properties, placeholder variables may also be used for non-case-specific parameters such as constant values (e.g., a plan sponsor name), a user's signature or a plan sponsor's logo. This allows certain parameters to be reused without the user manually having to input the parameter each time a notification is generated. It also allows the non-case-specific parameters to be updated independently of the templates, so that changes in the non-case-specific parameters (e.g., a new logo) are reflected in subsequently generated notifications. The UI 92 may be accessed from the UI 90 in FIG. 30 and displays a list of placeholder categories (e.g., case property, constant, signature or logo) together with an option to select the respective placeholder category (e.g., a radio button or check box) and instructions for insertion. Selecting a placeholder category causes a list of selectable placeholder variables associated with the selected category to be displayed. According to an example embodiment, placeholder variables are inserted into a designated location in the document by clicking on the designated location or otherwise selecting the designated location (e.g., by moving a cursor to the desired location), followed by double clicking on the placeholder variable.

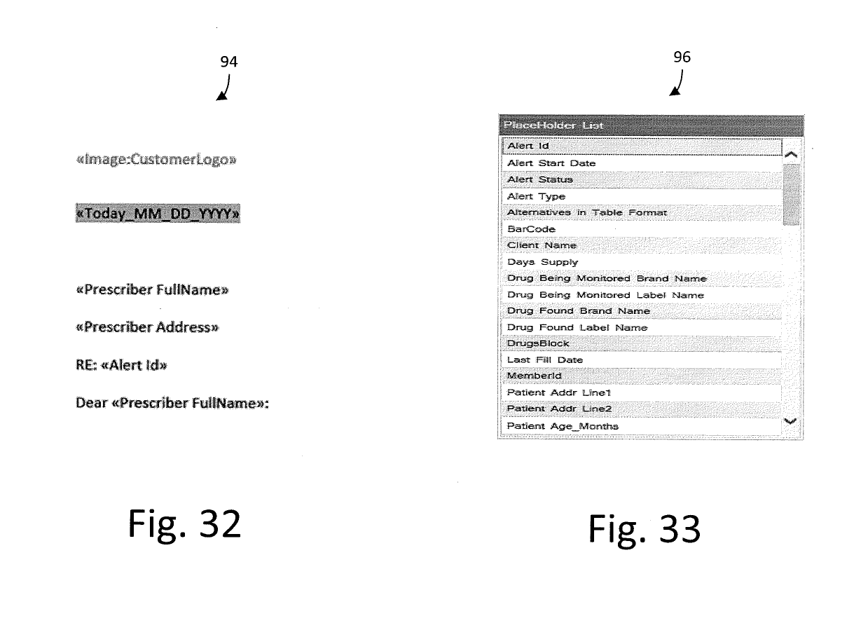

FIG. 32 shows an example UI 94 that shows different placeholder variables, as they appear after being inserted into a document. The example shown is a header of a letter to a prescriber. The placeholders are displayed surrounded by brackets.

FIG. 33 shows an example UI 96 that shows a list of potential placeholder variables including variables relating to the alert ID (e.g., the case ID in FIG. 25), alert start date (e.g., when the scenario was first triggered, alert status (e.g., case status), alert type (e.g., adherence rule type), a list of alterative medications, a medication bar code, client name, days supply, the name or label of a medication being monitored, the name or label of a medication found, last fill date, and patient information (e.g., member ID, address or age).

According to an example embodiment, the adherence monitoring system 200 provides a list of predefined placeholder variables, but allows the user to edit or create placeholder variables. In an example embodiment, the user is only allowed to edit non-case-specific variables. The user inputs the information for these variables once, and therefore, the system will generate notifications using the template by obtaining the actual value or image from a stored record associated with the placeholder variable. To create a placeholder variable, the user first selects the placeholder category (e.g., constant, logo or signature) and then supplies the necessary information for the actual value (e.g., uploading an image of a logo or signature).

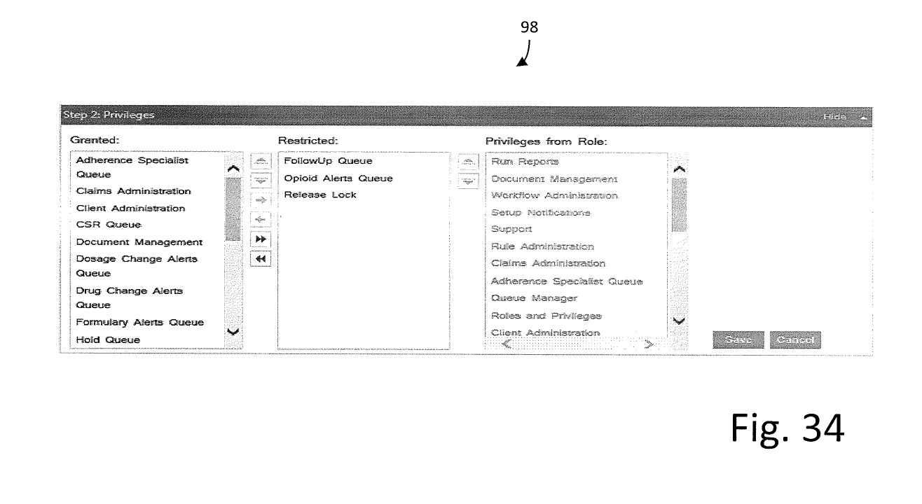

FIG. 34 shows an example UI 98 for assigning access privileges to users. The UI 98 may be accessed through the Administration option in FIG. 4. The ability to assign privileges may be restricted to plan sponsor users or administrators of the adherence monitoring service. Privileges may include access to specific queues and to perform specific categories of actions (e.g., claims administration or document management). The left column displays privileges that have been manually granted to the subject user. The middle column displays privileges that have been manually denied to the subject user. The right column shows privileges that are automatically assigned to the subject user by virtue of being associated with a particular user role.

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination, e.g., to output any one or more of the described graphical user interfaces, to generate notifications, to monitor medical adherence, etc. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

Example embodiments of the present invention are directed to one or more of the above-described methods, e.g., computer-implemented methods, alone or in combination.

The above description is intended to be illustrative, and not restrictive. Those skilled in the art can appreciate from the foregoing description that the present invention may be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and appendices. Further, steps illustrated in the flowcharts may be omitted and/or certain step sequences may be altered, and, in certain instances multiple illustrated steps may be simultaneously performed.

What is claimed is:

1. A computer-implemented method for monitoring a patient's adherence to a prescribed medication, comprising:
obtaining prior authorization (PA) data that includes historical information relating to a PA request for one of the prescribed medication and a related medication; and
analyzing, by a computer processor, the PA data based on a rule that defines a non-adherence condition.

2. The method of claim 1, wherein the non-adherence condition is based on a timing of when a decision to approve or deny the PA request was made.

3. The method of claim 1, wherein the rule defines non-adherence as being a failure to obtain the prescribed medication within a predefined time period after the PA request was approved.

4. The method of claim 1, wherein the rule defines non-adherence as being a failure to obtain an alternative medication within a predefined time period after the PA request was denied.

5. The method of claim 1, wherein the non-adherence condition concerns a quantity of a medication specified by the PA request.

6. The method of claim 1, wherein the non-adherence condition is further based on claims data that includes historical information relating to an insurance claim for one of the prescribed medication and the related medication.

7. The method of 6, further comprising:
analyzing the claims data based on the rule to determine whether the patient is adhering to the prescribed medication.

8. The method of 6, further comprising:
analyzing the claims data based on the rule to determine whether the patient is taking an alternative medication, which is an alternative to the prescribed medication.

9. The method of claim 1, further comprising:
responsive to a result of the analyzing indicating non-adherence, automatically generating a notification to one of the patient, a medication prescriber, a medication provider, and a patient representative.

10. The method of claim 1, further comprising:
receiving user input specifying that the patient's non-adherence should continue to be monitored when the analyzing indicates that the patient is not adhering; and
updating a case history for the patient to reflect future instances of non-adherence, as defined by the rule.

11. A computer-implemented method for creating a rule for monitoring a patient's adherence to a prescribed medication, comprising:
receiving, by a computer processor, a user request to create the rule, together with user input of rule criteria by which a non-adherence condition is defined for the rule, wherein the non-adherence condition describes non-adherence to the prescribed medication with respect to one of insufficient use, overuse, dangerous interactions with other medications, and use of a non-preferred medication;
generating the rule, by the processor, in response to the user input; and
storing the rule, by the processor, such that the stored rule causes the processor to analyze subsequently received prior authorization (PA) data describing a PA request for the prescribed medication to determine whether the condition is satisfied.

12. The method of claim 11, wherein the processor is configured to, based on the rule, monitor adherence in connection with a health plan rating system of the Centers for Medicare and Medicaid Services.

13. The method of claim 11, further comprising:
further defining the non-adherence condition based on criteria that must be met with respect to claims data that includes historical information relating to an insurance claim for one of the prescribed medication and a related medication.

14. The method of claim 13, wherein the rule criteria includes
at least one value corresponding to a time period since a last fill of the prescribed medication.

15. The method of claim 14, wherein the at least one value specifies a time window and the rule is defined so as to indicate non-adherence when analysis of the claims data indicates that the patient one of:
attempted to obtain the prescribed medication before a beginning of the window; and
failed to obtain the prescribed medication or an alternative medication by an end of the window.

16. A computer-implemented method for assigning non-adherence cases for review by users of a system that monitors patient adherence to prescribed medications, comprising:
maintaining a plurality of work queues, each queue associated with a different user role in the system;
assigning, by a computer processor, access to the queues to the users in accordance with their respective user roles;
opening a case in response to detecting an instance of non-adherence with respect to a particular prescribed medication; and
assigning, by the processor, the case to at least one of the queues based on a processor determination of a relevancy of the case to each queue.

17. The method of claim 16, further comprising:
determining, by the processor, that the case is relevant to a particular queue when an adherence rule, by which the instance of non-adherence was detected, is associated with the particular queue.

18. The method of claim 16, further comprising:
flagging the case for continued monitoring in response to a user request; and
reopening the case in response to a subsequent instance of non-adherence by the patient and to the particular prescribed medication.

19. The method of 16, further comprising:
responsive to a user request to close the case, removing the case, by the processor, from all queues in which the case was placed; and
after removing the case, responsive to a subsequent instance of non-adherence by the same patient and to the particular prescribed medication, assigning one of a new case and the same case to each queue from which the same case was previously removed.

20. A computer-implemented method for generating a notification in response to a patient's non-adherence to a prescribed medication, comprising:
storing, by a computer processor, an electronic template for generating a notification document addressing a notified party, including at least one of the patient, a prescriber of the medication, a provider of the medication, and a patient representative, the template including a placeholder variable that describes a parameter applicable to specific instances of non-adherence; and
responsive to detecting an instance of non-adherence by the patient, generating the notification document, by the processor, by replacing the placeholder variable with an actual value of the parameter.

21. The method of claim 20, further comprising:
outputting a graphical user interface by which a user selects the placeholder variable from a list of placeholder variables for insertion into the template at a user input location in the template.

22. The method of claim 20, wherein the placeholder variable corresponds to one of the patient's name, address, and health insurance information.

23. The method of claim 20, wherein the placeholder variable corresponds to one of a name and an address of a prescriber of the medication.

24. The method of claim 20, wherein the placeholder variable corresponds to one of a name and an address of a provider of the medication.

25. The method of claim 20, wherein the placeholder variable corresponds to one of a name, a quantity and a last fill date of the medication.
